(19) United States
(12) Patent Application Publication
(10) Pub. No.: US 2018/0259040 A1
(43) Pub. Date: Sep. 13, 2018

(54) FEED MIXER

(71) Applicant: Trioliet B.V., Oldenzaal (DE)

(72) Inventor: Cornelis Hendricus LIET, Losser (NL)

(21) Appl. No.: 15/759,250

(22) PCT Filed: Sep. 15, 2016
(86) PCT No.: PCT/EP2016/071824

§ 371 Date: Mar. 12, 2018

(30) Foreign Application Priority Data
Sep. 18, 2015 (DE) 20 2015 104 960.9

(51) Int. Cl. F16H 3/54; F16H 3/66; A01K 5/00

(52) U.S. Cl. CPC F16H 3/54; F16H 3/66; A01K 5/001; F16H 2200/2041; F16H 2200/2005; F16H 2200/2007; F16H 2200/2035; F16H 2200/0034

(57) ABSTRACT

The present invention relates to a feed mixer (F) comprising at least one rotatably drivable mixing member (M) and at least one planetary gear arranged on the feed mixer (F) and driving the mixing member (M), said planetary gear comprising a sun gear (25), a planetary gear carrier (22) with planetary gears (23) and a ring gear (24) as torque transmitting components in a housing (14) and being adapted to be shifted under load with at least one clutch (K) between at least two gear ratios. According to the present invention, the planetary gear comprises in the housing (14) a single clutch (K) between two of the components and on the housing (14) a brake (B), which is actuable on the feed mixer (F) and which can be used for optionally blocking one of the two components relative to the feed mixer (F) as well as for disengaging the clutch (K).

The present invention relates to a feed mixer of the type specified in the preamble of claim 1.

Feed mixers used in a stationary or mobile mode have a gear unit that is adapted to be shifted between at least two gear ratios, so as to drive the mixing member or mixing members slowly with a high torque for mixing and cutting the fodder, and so as to be able to drive the mixing member or mixing members with a lower torque, but at a higher speed, for cleaning out as the mixing chamber empties. In this context it is important that the gear unit shifts without interrupting the traction force, so as to prevent the mixing member from coming to a standstill during the shifting operation and from generating an extreme starting countertorque when restarting.

In the case of the feed mixer known from EP 0 880 890 A1, the gear unit is a planetary gear comprising two hydraulic clutches, which are incorporated into the interior of the planetary gear. The clutches are switched substantially simultaneously and alternately. One of the clutches connects two of the rotatable components of the planetary gear, while the other clutch is disengaged. The other clutch connects one of the rotatable components to the housing, while the first clutch is disengaged. It is structurally difficult to integrate the two clutches into the planetary gear, and many auxiliary components, such as oil pumps, cooling systems, electronic control units and the like, are required for allowing exact shifting. Due to the high torque to be transmitted, the clutches generate a large amount of heat, the engaging clutch generating more heat than the disengaging clutch. The engagement behavior between the clutches may thus vary in an uncontrolled manner and cause a poor heat balance that may easily result in wear in the planetary gear. In addition, the hydraulic clutches require a large amount of maintenance work. The disadvantageous heat balance and local heat pockets have a negative effect on the hydraulic medium, which has to be replaced comparatively often. In the case of feed mixers comprising more than one mixing member, such a complicated, shiftable planetary gear is required for each mixing member. According to another embodiment, an auxiliary hydraulic motor is provided, which, via a further gear unit, either mechanically blocks the ring gear of the planetary gear, which is provided with additional external teeth, from outside or rotates said ring gear with a variable speed so as to continuously vary the output speed of the planetary gear. This concept is extremely complicated from the structural point of view and it may be failure prone. The known planetary gear is expensive and, for reasons of price, inexpedient for comparatively small feed mixers having a capacity of e.g. 16 to 30 m³.

In the case of the feed mixer known from EP 1 561 971 A1, one embodiment comprises, in the planetary gear, at least a roller-free-wheel unit as well as an auxiliary hydraulic motor, which, for activating the freewheel, acts on the planetary gears in the planetary gear carrier via an additional adjustment gear.

U.S. Pat. No. 5,462,354 A discloses a feed mixer in the case of which the only mixing member is driven via an angular planetary gear, which is connected to an automatic gearbox via a universal shaft, said automatic gearbox being driven by the power take-off shaft of the tractor. Alternatively, a variable hydraulic motor may be provided instead of the automatic gearbox.

It is the object of the present invention to equip a feed mixer of the type specified at the beginning with a structurally simple, shiftable planetary gear, which allows the use of a simple, reliable and low-maintenance drive system, especially for comparatively small feed mixers, at a reasonable price and without any complicated auxiliary components or control units.

The posed task is solved by the features of claim 1.

The single clutch can easily be integrated in the planetary gear and it is reliable in function and resistant to heat to a very large extent. The same applies to the brake, which is arranged on or within the housing and which has a dual function insofar as it is capable of blocking one of the components of the planetary gear through friction and insofar as it simultaneously disengages the clutch by a positioning movement during blocking or when actuated. The planetary gear has a compact structural design, it is cost-effective and it requires little maintenance. It fulfills the demands in a feed mixer almost ideally with little effort and expenditure, and this leads, especially in the case of comparatively small feed mixers, to a reasonable price and requires little installation space. When a plurality of mixing members or mixing chambers is provided, a planetary gear may be installed before each mixing member, or it may drive a plurality of mixing members centrally. Departing from a planetary gear with a plurality of hydraulic clutches, roller-free-wheel units and hydraulic auxiliary drives is atypical for feed mixers and fulfills the given requirements in a surprisingly simple manner. Using, for the comparatively high torques and the comparatively low speeds in a planetary gear for feed mixers, a brake for blocking on the one hand and for disengaging a clutch on the other has hitherto been refused by feed mixer design engineers for lack of usefulness and insufficient reliability.

As regards control technology, the brake can easily be actuated hydraulically simply by a pressure pulse, without requiring any complicated auxiliary components or control elements, it is reliable and it requires little maintenance. In a particularly expedient manner, the brake can even be actuated mechanically, so that the planetary gear can be shifted without a hydraulic system and without interrupting the traction force during shifting.

According to an expedient embodiment, the clutch is a friction clutch and can be engaged by the force of a spring. Disengagement is effected by the positioning movement of the actuated brake. The brake may be actuated mechanically, hydraulically, pneumatically or electrically.

It will be particularly expedient to configure the brake as a disk brake, which is reliable, efficient and resistant and which, when actuated, executes a positioning movement that can advantageously be used for disengaging the clutch. Alternatively, other brakes, from the actuation of which a positioning movement can be derived, may be used.

According to an expedient embodiment, the braking force of the brake used for disengaging the clutch exceeds the spring force used for engaging the clutch, so that the clutch will be disengaged quickly and uniformly while sufficient braking force for blocking the component of the planetary gear will still be available. The braking force of the brake produces here an axial positioning movement, which is directly mechanically transmitted to the clutch in the planetary gear, so that the clutch and the brake will shift largely simultaneously and very quickly between the gear ratios. The brake will here advantageously be effective across a comparatively large diameter, so that a moderate braking force will suffice for reliable blocking and a sufficiently large part of the braking force will be available for disengaging the clutch.

For designing the planetary gear, e.g. two concepts can be used advantageously. The clutch may be effective either between the sun gear and the planetary gear carrier, whereas the brake acts on the sun gear. Alternatively, the clutch may be effective between the planetary gear carrier and the ring gear, the brake acting on the ring gear in this case. This, however, shall not exclude the possibility of optionally arranging the clutch between the sun gear and the ring gear and positioning the brake such that it acts on the planetary gear carrier. According to an expedient embodiment, the planetary gear is installed such that it drives the mixing member either 1:1 or slower.

According to an expedient embodiment, a second shaft supported in the housing is connected to the ring gear or the sun gear and a first coaxial shaft, which is also supported in the housing, is connected to the planetary gear carrier or the ring gear. The sun gear or the ring gear may be supported e.g. on the first shaft or the second shaft and the planetary gear carrier. This should not be interpreted restrictively, since also many other support principles can be realized for the rotatable components of the planetary gear. For guaranteeing a desired gear reduction at the output shaft, which is here the first shaft, the planetary gear carrier will always be connected to the output shaft.

According to an expedient embodiment, the clutch comprises displaceable clutch ring disks, which are alternately connected to the two components in a rotationally fixed manner and which are arranged between a clutch pressure plate and a stop in one of the two components, said clutch pressure plate being axially movable by the positioning movement derived from the brake. The spring force of the clutch acts on the clutch pressure plate, which functions purely mechanically.

In the event that more than two shiftable speed levels should be necessary in the feed mixer, at least two, preferably differently sized planetary gears may be arranged in succession between the first and the second shaft, each of said planetary gears comprising a spring-actuated mechanical clutch and a mechanically or hydraulically actuable brake. The brakes may be actuated simultaneously or individually. In order to achieve optimum mechanical conditions, the respective larger planetary gear is installed closer to the mixing member than the respective smaller planetary gear.

According to an expedient embodiment, the brake comprises, in or on the housing, two coaxial disks and at least two opposed brake shoes, which are adapted to be pressed against said disks from outside. The disks are connected to one of the two components such that they are rotatable together therewith and are spaced apart in the engaged condition of the clutch. One of the disks defines either the clutch pressure plate, which is acted upon by the spring force of the clutch, or is adapted to be brought into engagement via stops or pressure pins with the other clutch pressure plate, so as to transmit the positioning movement.

It will be expedient when the brake shoes of the hydraulically operable brake are operable by pistons in hydraulic cylinders constituting a fixed part of the housing or when brake shoes of the mechanically operable brake are operable by a lever mechanism on the housing. For the brake shoes one or a plurality of resetting springs acting in a release direction may be expedient.

Another expedient embodiment of the mechanically or hydraulically operable brake, e.g. a disk brake, comprises two toothed washers, which abut on one another and constitute, in principle, fixed parts of the housing and which each have circumferentially distributed, oppositely directed sawteeth that face one another, said toothed washers being adapted to be rotatably displaced relative to one another to a limited extent within the housing hydraulically or by at least one lever mechanism while the wedge-shaped sawteeth slip on one another and the positioning movement and the braking force are being produced. This relative movement can be caused by rotatably displacing only one of the washers or by rotatably displacing both toothed washers simultaneously in opposite directions. One of the toothed washers is pressed with a brake pad against the clutch pressure plate or the disk coupled to the clutch pressure plate, while the positioning movement is taking place, and moves the clutch pressure plate into contact with a disk of one of the components, preferably of the sun gear, and presses this disk via a brake pad against at least one brake shoe constituting a fixed part of the housing or a braking surface constituting a fixed part of the housing. In this way, a precisely predetermined positioning movement can be produced via the wedge effect of the sawteeth with a moderate driving force and the braking force is supported in a mechanically stable manner as along as the disk brake is actuated. Another advantageous effect is that the sawteeth will be able to automatically compensate the wear that will occur over time. If only one of the toothed washers is rotatably displaced, and this should expediently be the toothed washer facing away from the brake shoes, the other one can be anchored such that it constitutes a fixed part of the housing.

In a structurally simple manner and for a reliable, self-retaining blocking position of the actuable brake, it will be expedient when, at least with the brake applied, the lever mechanism is blocked, locked in place or occupies a self-retaining beyond-dead-center position on the housing or in a tractor.

If the various bearings in the planetary gear are not provided with permanent lubricant supplies, the housing may comprise an oil bath that is sealed to the outside.

A further important aspect is to be seen in that at least one sensor is provided in or on the housing, said sensor being used at least for monitoring the duly blocking braking function of the applied brake. This sensor may be connected to a superordinate control in a signal-transmitting manner, so that malfunction can be indicated immediately.

For hydraulically actuating the brake, a hydraulic circuit may, in a structurally simple manner, comprise a hydraulic line connected to a magnetically operated manifold valve, the hydraulic line having provided therein a check valve, which shuts off in the flow direction towards the manifold valve and which is hydraulically unlockable via the manifold valve, said check valve being arranged between a flow control valve comprising preferably a control orifice and a parallel check valve, which opens in the flow direction towards the manifold valve, and optionally a pressure reservoir connected to the hydraulic line, and the manifold valve. The manifold valve is preferably a 4/3-way valve with a blocking neutral position and it is connected to a pressure source and a return. This hydraulic circuit is structurally simple and requires only a small number of cost-efficient and functionally reliable components.

It will be expedient when the manifold valve is a tractor valve in the hydraulic system of a tractor coupled to the mobile feed mixer or to the stationary feed mixer and driving a shaft of the planetary gear, e.g. via the power take-off shaft, with a comparatively high speed, which can be reduced via the planetary gear. Alternatively, a hydraulic motor or an electric motor may serve as a drive source.

Finally, it will be expedient for the mechanically actuable brake, when the lever mechanism is operable via a Bowden cable on the feed mixer or in a tractor associated with the feed mixer. The Bowden cable can be operated from a strategically suitable point, so that no direct manual action will be necessary at the location of the planetary gear, which may possibly be difficult to access.

Embodiments of the subject matter of the present invention are explained making reference to the drawing, in which

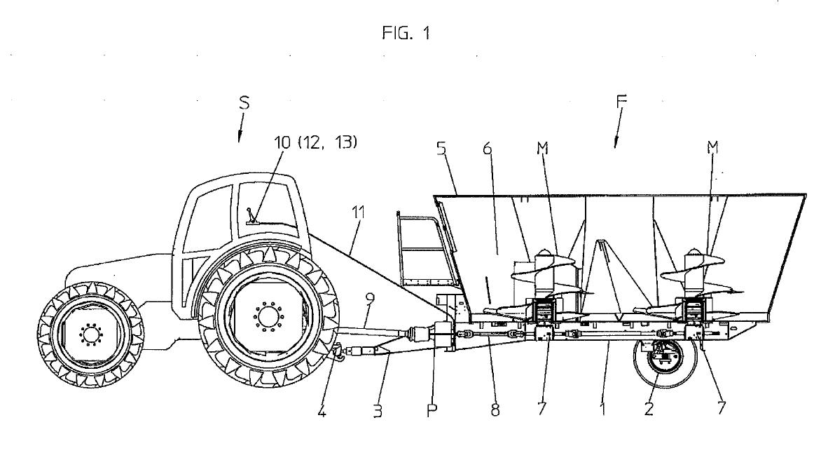

FIG. 1 shows a side view, part of which is a sectional view, of a feed mixer, which, as a non-limiting example, is mobile and which is coupled to a tractor, said feed mixer comprising, as a non-limiting example, two mixing members in a mixing chamber,

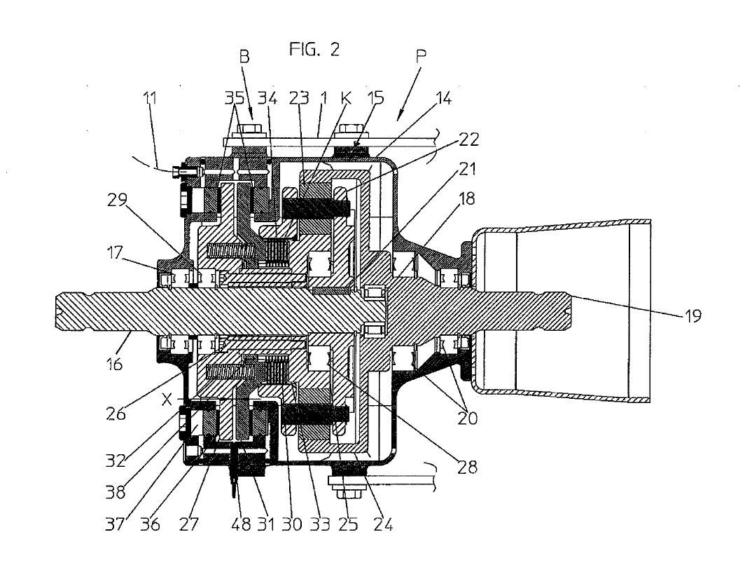

FIG. 2 shows a longitudinal section of a first embodiment of a shiftable planetary gear at a shift position for a 1:1 gear ratio,

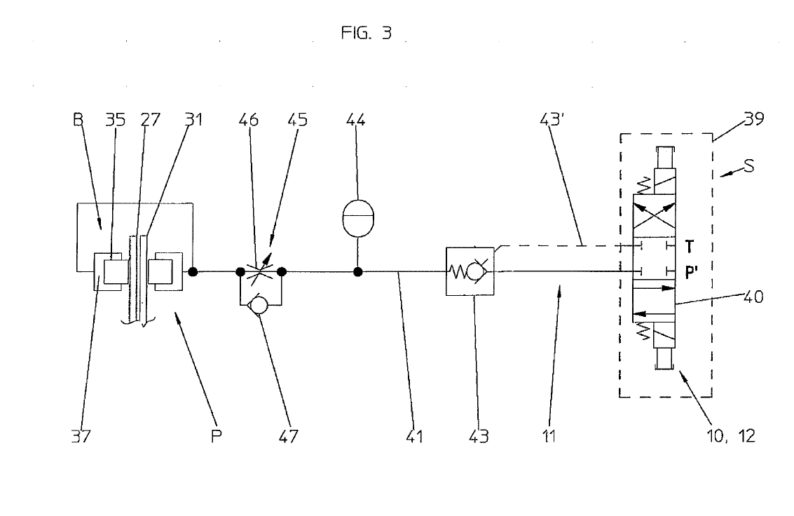

FIG. 3 shows a block diagram of a hydraulic circuit, e.g. for the planetary gear in FIG. 2 comprising a hydraulically actuable disk brake,

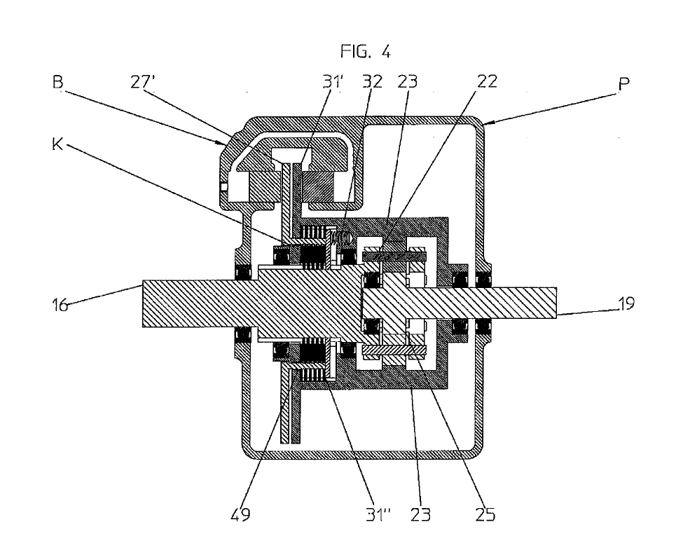

FIG. 4 shows a further embodiment variant of the planetary gear,

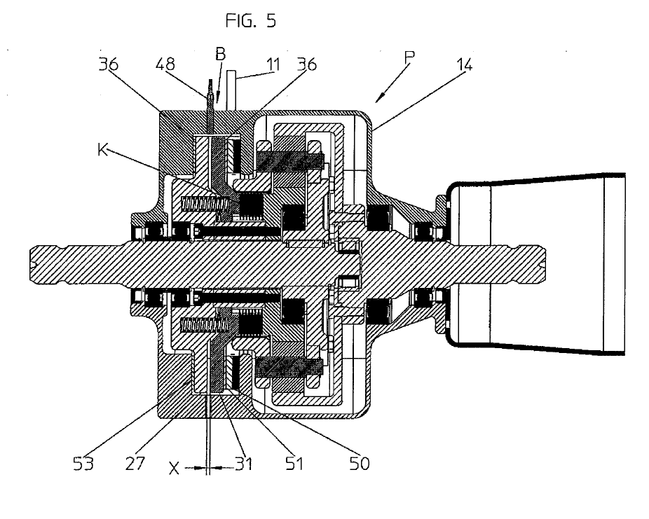

FIG. 5 shows a further embodiment of the planetary gear,

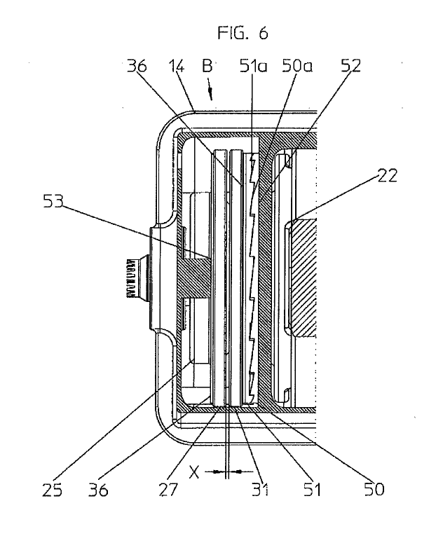

FIG. 6 shows a scaled-up sectional view of details of the embodiment according to FIG. 5 at a shift position,

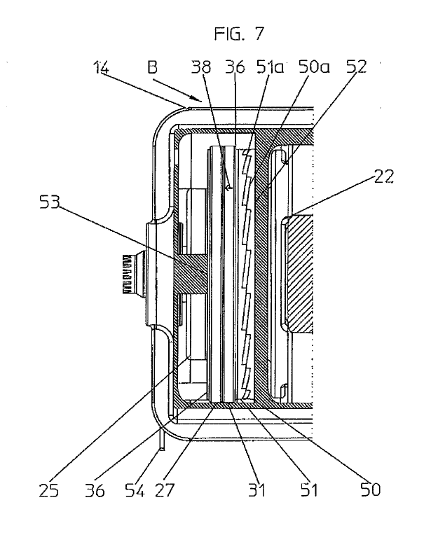

FIG. 7 shows a sectional view corresponding to that of FIG. 6, at a different shift position,

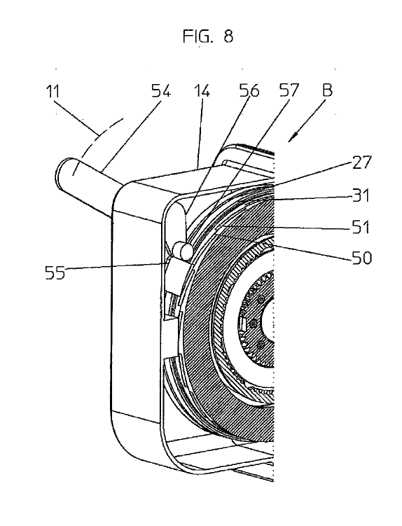

FIG. 8 shows a perspective view of the shift position according to FIG. 7, and

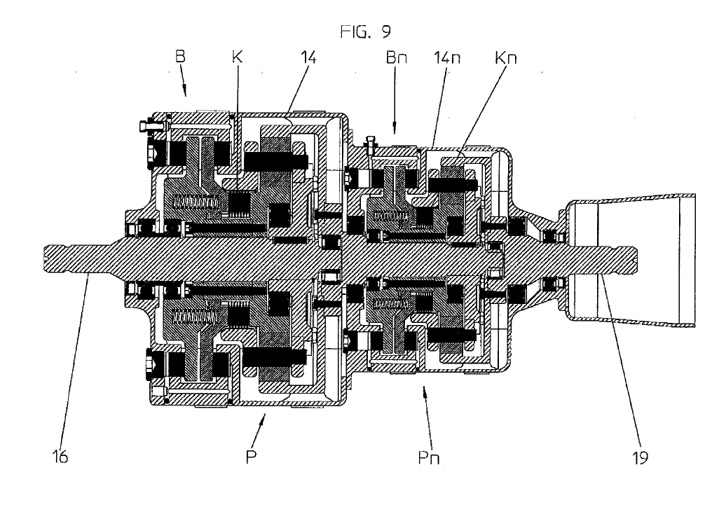

FIG. 9 shows a sectional view of a multi-stage planetary gear for shifting e.g. between three different gear ratios.

In FIG. 1 a feed mixer F comprises an undercarriage 1, which can here be run e.g. on wheels 2 and which is coupled via a drawbar 3 to a connection 4 of an associated tractor S. The undercarriage 1 carries here exemplarily only one mixing container 5 that delimits a mixing chamber 6 which, in the embodiment shown, has arranged therein two mixing members M, e.g. mixing screws, in a rotationally drivable manner.

The feed mixer F may also comprise a plurality of mixing containers, a plurality of mixing chambers and more than two mixing members, or only one container comprising one mixing chamber and one mixing member, it may be a horizontal mixer, a paddle mixer or some other type of mixer.

In FIG. 1 each mixing member M is driven via an angular gear or an angular planetary gear 7 (e.g. with a gear reduction of approx. 16:1 to 18:1 with a 540 rpm power take-off shaft or +/−26:1 with a 1000 rpm power take-off shaft) by a cardan shaft train 8 leading to a planetary gear P, which is stationarily installed on the undercarriage 1 and driven e.g. by a power take-off shaft 9 of the tractor S.

In the case of a stationary embodiment of the feed mixer F, the latter may have a separate drive for the planetary gear P. Alternatively, each mixing member M in FIG. 1 may be driven by a planetary gear P installed before the angular gear 7.

The planetary gear P is adapted to be shifted between at least two gear ratios such that substantially no interruption of the traction force occurs, so as to drive the respective mixing member M with a high torque and a comparatively low speed or with a lower torque and a higher speed. To this end, FIG. 1 indicates an actuator 11 for switching the planetary gear P, said actuator 11 being connected to an actuating device 10 in the tractor S in the embodiment shown. The actuating device 10 may be a hydraulic actuating device 12 or a mechanical actuating device 13. It will be expedient when said actuating device 10 is, at the respective adjusted position, blocked, locked in place or at a beyond-dead-center position.

In an embodiment that is not shown, the actuating device 10 may be provided directly on the feed mixer M.

The embodiment of the planetary gear B in FIG. 2 is stationarily fixed in position, e.g. on anchorings 15 of a housing 14, in the undercarriage 1 of the feed mixer according to FIG. 1. A shaft 16 extends into the planetary gear P, said shaft 16 being supported by bearings 17 in the housing 14 and by bearings 18 in a second shaft 19 that extends to the outside of the housing 14. The second shaft 19 is supported in the housing by bearings 20 and is connected to a ring gear 24 defining a rotatable component of the planetary gear. The first shaft 16 is connected to a planetary gear carrier 22 as a further rotatable component, e.g. via splines 21, said planetary gear carrier 22 being used for rotatably supporting a plurality of planetary gears 23, which are in mesh with internal teeth of the ring gear 24. Finally, a sun gear 25 is rotatably supported on the first shaft 16 by bearings 28, here on the planetary gear carrier 22 and 29, as a further rotatable component of the planetary gear P, said sun gear 25 meshing with the planetary gears 23 and being connected to a large-diameter disk 27 via clamping screws 26. It will be expedient when e.g. the second shaft 19 is the input shaft, whereas the first shaft 16 is the output shaft to the mixing member M.

The planetary gear carrier 22 and the sun gear 25 have provided between them a mechanical clutch K, which is engageable by the force of a spring 32 and which comprises a clutch pressure plate configured as a disk 31, said clutch pressure plate being acted upon by the force of the spring 32, supported in the disk 27, in the direction of engagement and being axially movable and capable of acting on an arrangement 30 of clutch ring disks 34, which are alternately connected to the planetary gear carrier 22 and the sun gear 25 in a rotationally fixed manner, but axially displaceable, and which rest on a stop 33, here in the sun gear 25. In addition, a brake, i.e. a friction brake, preferably a disk brake, is provided on or in the housing 14. In the embodiment according to FIG. 2, a hydraulically operable disk brake is provided as a brake B.

The disk brake comprises two brake shoes 35 arranged on pistons in cylindrical chambers 37 of the housing, the brake shoes 35 being, with brake pads 36, oriented from outside towards the two disks 31 and 27 and being adapted to be hydraulically acted upon via the actuator 11 so as to act on the disks 27, 31, lock the latter against a rotary movement and press them against one another also via a positioning movement having a predetermined stroke (arrow 38) so as to eliminate a distance X between the disks 27, 31 existing in the depicted engaged position of the clutch K. The cylindrical chambers 37 are pressure connected to the hydraulic actuator 11 via joint passages.

Optionally, the housing 14 may have provided thereon a sensor 48, which is in signal-transmitting communication e.g. with a superordinate control and which monitors and indicates a duly blocking braking function of the disk brake.

At the shift position shown in FIG. 2, the clutch K has been engaged by the spring force 32, i.e. the disk 31 of the clutch pressure plate presses the clutch ring disks 34 against one another and against the stop 33, so that the planetary gear carrier 22 is coupled to the sun gear 25 in a rotationally fixed manner. The brake B has been released so that the two disks 31, 27 can rotate relative to the brake pads 36. Hence, the speed of the second shaft 19 is transmitted 1:1 to the first shaft 16.

At the second shift position, i.e. with the brake B applied, the two disks 27, 31 are pressed against one another by the braking force between the brake shoes 35 and locked against a rotary movement. Upon overcoming the distance X between the disks 27, 31, the positioning movement 38 indicated by an arrow (in FIG. 2 to the left) is transmitted to the disk 31 of the clutch pressure plate, said positioning movement 38 overcoming the spring force 32 and releasing the clutch ring disks 34 from frictional engagement. To this end, the braking force of the brake B exceeds the spring force 32. Through the applied brake B, the disks 27, 31 and thus the sun gear 25 are held in place relative to the feed mixer F and the housing 14, respectively, while the planetary gear carrier 22 coupled to the first shaft 16 is rotatable relative to the sun gear 25. The second shaft 19 is preferably driven by the tractor S. The ring gear 24 drives the planetary gears 23, which rotate the planetary gear carrier 22 in the direction of rotation of the drive shaft at a lower speed, corresponding to the number-of-teeth ratio between the sun gear and the ring gear (gear reduction e.g. 1.7-1.8:1).

FIG. 3 illustrates a possible embodiment of a hydraulic actuator 11 for the hydraulically operable brake of the embodiment of the planetary gear P according to FIG. 2.

A hydraulic line 41 extends from a manifold valve 40, here a 4/3-way valve with a blocking neutral position, which is arranged in a hydraulic system 39 of e.g. the tractor S and connected to a pressure supply P′ and a return T, to the cylindrical chambers 37 of the brake B, which is here configured e.g. as a disk brake, in the planetary gear P. The hydraulic line 41 has provided therein, downstream of the manifold valve 40, a check valve 43, which is hydraulically unlockable via a control line 43′ and which shuts off in a flow direction towards the manifold valve 40. Between the check valve 43 and the cylindrical chambers 37, the hydraulic line 41 may have connected thereto a pressure reservoir 44. It will suffice when said pressure reservoir 44 has a capacity of e.g. 10 cm³ in the case of an 150 bar pressure limited by a pressure limiting valve, which is not shown. The pressure reservoir 44 is optional. Upstream of the cylindrical chambers 37, the hydraulic line 41 has finally arranged therein a flow control valve 45 consisting e.g. of a control orifice 46 for varying the flow cross-section and of a bypassing check valve 47, which shuts off in the flow direction towards the cylindrical chambers 37. The manifold valve 40 is e.g. magnetically operated and is controlled via the actuating device 10, e.g. a joystick or a switch 12 for hydraulic actuation, shown in FIG. 1. In the case of older tractors, this “tractor valve” may be actuated by a lever in the cab.

In the depicted blocking neutral position of the manifold valve 40, the cylindrical chambers 30 have applied thereto e.g. pressure from the pressure reservoir 44. The check valve 43 is in the shut-off state. The hydraulic line 41 is isolated from the pressure supply P′ as well as from the return T. Alternatively, the cylindrical chambers 30 and the pressure reservoir 44 may not be under pressure at the neutral position.

When the manifold valve 40 is moved to the lower switching position, the hydraulic line 41 is connected to the pressure supply P′, whereas the control line 43′ is connected to the return. The pressure effective in the hydraulic line 41 opens the check valve 43, feeds the pressure reservoir 44 and generates a predetermined pressure in the cylindrical chambers 37 so as to actuate the brake B, the build-up of said pressure being controlled by the flow control valve 45.

When the manifold valve 40 is moved to the upper switching position, the hydraulic line 41 is connected to the return T, whereas the control line 43′ is connected to the pressure supply P′. This has the effect that the check valve 43 is controlled to be open, so that the pressure will be discharged comparatively fast, also via the check valve 47 which will then open, from the cylindrical chambers 37 to the return T. Also the pressure reservoir 44 can be evacuated. The disk brake is no longer operated. By the way, it will be expedient when the manifold valve 40 is the so-called tractor valve or when, in the case of a stationary feed mixer F, it is arranged and actuable in a hydraulic system on the feed mixer itself.

The embodiment of the planetary gear P outlined in FIG. 4 differs from the embodiment according to FIG. 2 insofar as the clutch K is provided between the ring gear 23 and the planetary gear carrier 22, whereas the brake B acts on a disk 31′, which is connected to the ring gear 23 in a rotationally fixed manner, and on the disk 27′ that is axially movable in the ring gear 23. The sun gear 25 is connected to the second shaft 19 in a rotationally fixed manner, whereas the planetary gear carrier 22 is connected to the first shaft 16 in a rotationally fixed manner. Pressure pins 49 extend from the disk 27′ to the clutch pressure plate 31″, which is positioned on the first shaft 16 as a separate disk guided in an axially movable manner and which is acted upon by the spring force 32 in the engagement direction of the clutch K. The first shaft 16 is rotatably supported in the ring gear 23 and on the second shaft 19. The planetary gear carrier 22 is connected to the first shaft 16.

At the depicted engagement position of the clutch K, the planetary gear carrier 22 is coupled to the ring gear 23 in a rotationally fixed manner. The first shaft 16 is driven by the second shaft 19 with a 1:1 gear ratio. When the brake B is operated, the disk 31′ is pressed against the disk 27′ and both disks are blocked. The resultant positioning movement 38 is transmitted via the mechanical connection 49 to the disk 31′ (clutch pressure plate 31′), which will overcome the spring force 32 and disengage the clutch K. The planetary gears 23 roll on the rotating sun gear 25 and within the ring gear 23, so that the planetary gear carrier 22 will be driven and the first shaft 16 will rotate at a lower speed than the second shaft 19 (gear reduction e.g. 1.7:1-1.8:1).

FIGS. 2 and 4 each show a hydraulically operable disk brake. Alternatively (not shown), the brake shoes 35 of the disk brake may, however, be operated mechanically, e.g. via a lever mechanism which is not shown in FIGS. 2 and 4, expediently via a Bowden cable or a hand lever or the like.

The embodiment of the planetary gear P in FIG. 5 differs from that according to FIG. 2 insofar as the disk brake has a different actuator. In the case of this actuator, two coaxial toothed washers 50, 51 are provided in the housing 14 next to the disk 31 (clutch pressure plate) of the clutch K, said toothed washers being rotatable relative to one another so as to produce the positioning movement 38 for overcoming the distance X, press the disks 27, 31 against one another and block them in the housing 14. Both disks 50, 51 may be rotatable relative to one another, either hydraulically or mechanically, or the toothed washer 50 is installed such that it constitutes a fixed part of the housing and only the toothed washer 51 is rotatable to a limited extent. On both sides of the disks 27, 31, brake pads 36 may be provided. The brake pad located on the left hand side in FIG. 5 may abut on or be attached to a plurality of brake shoes, which constitute a fixed part of the housing, or a braking surface 53.

Furthermore, a sensor 48 is again outlined on the housing 14 in FIG. 5, said sensor 48 being adapted to be used for monitoring the correctly blocking brake actuation.

The function of actuating the brake B of FIG. 5 is explained on the basis of FIGS. 6 to 8.

FIG. 6 shows the switching position according to FIG. 5, i.e. the switching position corresponding to the engaged clutch K and the released brake B. The two toothed washers 50, 51 have oppositely directed, wedge-shaped sawteeth 50a, 51a on the sides facing one another, said sawteeth 50a, 51a being circumferentially distributed. Since the sawteeth 50a, 51a are in full engagement with one another in FIG. 6, the disks 27, 31 are spaced apart from one another at the distance X under the force of the spring 32 and are not in braking engagement with the brake shoes 53 or the washer 51.

In FIG. 7, the washers 50, 51 are rotated relative to one another for actuating the brake B and disengaging the clutch K. For example, only the washer 51 may be rotated relative to the washer 50 via a lever mechanism 54 and such that the sawteeth 50a, 51a slip on one another and the washer 51 with the brake pad 36 presses the disk 31 by the positioning movement 38 against the disk 27 and the brake pad 36, so that the disks 27, 31 are locked such that they are fixed relative to the housing. The positioning movement 38 is transmitted to the clutch K for disengaging the latter.

According to FIG. 8, the lever mechanism 54 is rotatably supported on the housing 14 and is connected, via a crank 56, to a driver 57, which is oriented towards a stop 55, provided here on the toothed washer 51, and which rotatably displaces this stop 55 in the housing, possibly against the force of a return spring, which is not shown. The actuator 11, e.g. a Bowden cable, acts on the lever mechanism 54 and holds the toothed washer 51 at the position shown according to FIG. 7.

Alternatively, the washer 51 (or in the opposite direction also the washer 50) may rotatably be displaced hydraulically, so as to operate the disk brake (not shown).

The disk brake B may alternatively engage between the disks 27, 31. The disk brake B may also be designed according to the principle of the firm of KNOTT, so as to make the disks expand with less friction, or it may be designed according to the CONAX brake principle of the firm of DESCH such that it comprises a brake material, which is triangular in cross-section and which acts on the housing, and conical pressure disks. Also a drum brake or a band brake would be suitable for use. A prerequisite that must always be fulfilled is that, when the brake is operated, the positioning movement (arrow 38) is given and the braked parts are at a standstill relative to the housing 14.

FIG. 9 illustrates a drive system of the feed mixer, which, making use of the principle of the above-mentioned planetary gear P, allows switching of more than two different gear ratios. In FIG. 9 two e.g. differently sized planetary gears P and Pₙ are provided one after the other between the first and second shafts 16, 19, each of said planetary gears comprising a mechanical clutch K, Kn and a brake B, B_{N}. It will be expedient to install the larger planetary gear P closer to the mixing member M.

If neither of the two brakes B, Bₙ is operated and if both clutches K, Kₙ are engaged, the gear ratio will be 1:1. If e.g. the brake B, i.e. the brake that is effective across a larger diameter, has been operated, the gear reduction will e.g. be 1.7:1 to 1.8:1. If both brakes B, B_{N} have been operated and both clutches K, Kₙ disengaged, the gear reduction will e.g. be 1.7:1×1.7:1. In the case of an unequal ratio of the planetary gears P, Pₙ, it would even be possible to shift to a fourth speed level. If even more gear reductions should be desired, more than two planetary gears could be arranged one after the other.

1. A feed mixer comprising:
at least one rotatably drivable mixing member and at least one planetary gear arranged on the feed mixer and driving the mixing member, said planetary gear comprising a sun gear, a planetary gear carrier with planetary gears and a ring gear as torque transmitting components in a housing and being adapted to be shifted under load with at least one clutch between at least two gear ratios, wherein the planetary gear comprises in the housing a single clutch between two of the components and on the housing a brake, which is actuable on the feed mixer and which can be used for optionally blocking one of the two components relative to the feed mixer as well as for disengaging the clutch.

2. The feed mixer according to claim 1, wherein the clutch is automatically engageable under the force of a spring and is indirectly disengageable by operating the brake, and that the brake is mechanically or hydraulically or electrically or pneumatically actuable by a positioning movement.

3. The feed mixer according to claim 1, wherein the brake is a disk brake.

4. The feed mixer according to claim 2, wherein the braking force of the brake used for disengaging the clutch exceeds the spring force used for engaging the clutch, and that the axial positioning movement of the brake in the planetary gear can be transmitted mechanically to the clutch.

5. The feed mixer according to claim 1, wherein the clutch is effective either between the sun gear and the planetary gear carrier and the brake acts on the sun gear or that the clutch is effective between the planetary gear carrier and the ring gear and the brake acts on the ring gear.

6. The feed mixer according to claim 1 wherein in the planetary gear, a second shaft, preferably an input shaft, which is supported in the housing, is connected to the ring gear or the sun gear, and that a first coaxial shaft, which is also supported in the housing, is connected to the planetary gear carrier, and that, preferably, the sun gear or the ring gear is rotatably supported on the second shaft or on the first shaft and the planetary gear carrier.

7. The feed mixer according to claim 3, wherein the clutch comprises displaceable clutch ring disks, which are alternately connected to the two components in a rotationally fixed manner and which are arranged between a clutch pressure plate and a stop in one of the two components, said clutch pressure plate being axially movable by the positioning movement.

8. The feed mixer according to claim 1 wherein for allowing more than two gear ratios to be shifted in the planetary gear, at least two planetary gears are arranged in succession between the first and second shafts, each comprising a mechanical clutch and a mechanically or hydraulically actuable brake, the respective larger planetary gear being preferably arranged closer to the mixing member.

9. The feed mixer according to claim 1, wherein the brake comprises, in the housing, two coaxial disks and at least two opposed brake shoes which are adapted to be pressed against said disks from outside, that the disks are connected to one of the two components such that they are rotatable together therewith and are spaced apart in the engaged condition of the clutch, and that one disk defines either the clutch pressure plate, which is acted upon by the spring force of the clutch or abuts on a separate clutch pressure plate via stops.

10. The feed mixer according to claim 8, wherein the brake shoes of the hydraulically operable brake are operable by pistons in hydraulic cylinders constituting a fixed part of the housing or that brake shoes of the mechanically operable brake are operable by a lever mechanism on the housing, preferably against resetting forces acting in a release direction.

11. The feed mixer according to claim 1, wherein the brake comprises two toothed washers, which abut on one another and constitute, in principle, fixed parts of the housing and which each have circumferentially distributed, oppositely directed, wedge-shaped sawteeth that face one another, said toothed washers being adapted to be rotatably displaced relative to one another to a limited extent within the housing hydraulically or by at least one lever mechanism while the sawteeth slip on one another and while the positioning movement is being produced, that a toothed washer is adapted to be pressed with a brake pad against the clutch pressure plate while the positioning movement is taking place, and moves the clutch pressure plate into contact with a disk of one of the components, preferably of the sun gear, and presses this disk via a brake pad against at least one brake shoe constituting a fixed part of the housing or a braking surface constituting a fixed part of the housing.

12. The feed mixer according to claim 9 wherein at least with the brake applied, the lever mechanism is blocked, locked in place or occupies a self-retaining beyond-dead-center position on the housing or in a tractor.

13. The feed mixer according to claim 1 wherein the housing has provided therein at least one sensor, which preferably communicates with a superordinate control and which is used at least for monitoring the duly blocking braking function of the applied brake, preferably in orientation with respect to one of the disks.

14. The feed mixer according to claim 1 wherein a hydraulic circuit of the hydraulic brake actuator comprises a hydraulic line connected to a magnetically operated manifold valve, preferably a 4/3-way valve with a blocking neutral position, the hydraulic line having provided therein a check valve, which shuts off in the flow direction towards the manifold valve and which is hydraulically unlockable via the manifold valve, said check valve being arranged between a flow control valve comprising preferably a control orifice and a parallel check valve, which opens in the flow direction towards the manifold valve, and optionally a pressure reservoir connected to the hydraulic line, and the manifold valve.

15. The feed mixer according to claim 13, wherein the manifold valve is a tractor valve in the hydraulic system of a tractor coupled to the mobile feed mixer or to the stationary feed mixer and driving a shaft of the planetary gear.

16. The feed mixer according to claim 9 wherein the lever mechanism is operable via a Bowden cable or the like on the feed mixer or in a tractor associated with the feed mixer.

17. A feed mixer having a mixing member comprising:
a drive assembly having an input shaft and an output shaft driving the mixing member;
said drive assembly comprising a planetary gear assembly, a clutch, a first disk, a second disk, and a brake acting on the first and second disk by moving the first and second disk together;
the planetary gear assembly comprising a ring gear, a planetary gear carrier, a planetary gear, and a sun gear;
wherein the input shaft is fixed to the ring gear and the output shaft is fixed to the planetary gear carrier;
wherein the first disk is fixed to the sun gear and the second disk is coupled to the clutch with the clutch selectively engaging and disengaging the planetary gear carrier and the sun gear so that when the clutch is engaged the planetary gear carrier is coupled to the sun gear in a rotatably fixed manner whereby a rotation of the input shaft is the same as the output shaft; and
wherein when the clutch is disengaged by application of the brake acting on the first and second disk locking the first and second disk from rotary movement the sun gear is held in place and the planetary gear carrier coupled to the output shaft rotates relative to the sun gear, whereby a rotation of the input shaft is greater than the output shaft,
whereby the mixing member is capable of being driven at low speed for mixing and at high speed for cleaning.
